(19) United States
(12) Patent Application Publication
(10) Pub. No.: US 2008/0102703 A1
(43) Pub. Date: May 1, 2008

(54) Bulb holder with improved structure

(76) Inventor: Ming-chi Tseng, Wufong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/590,893

(22) Filed: Nov. 1, 2006

(51) Int. Cl. H01R 13/66

(52) U.S. Cl. 439/620.02

(57) ABSTRACT

A bulb holder with an improved structure comprising a bulb socket having a first connector with a first combining segment at one end thereof for being fastened to the bulb socket wherein the first combining segment has a first sidewall perpendicularly extending comprising a first fixing portion, and a base casing having a second connector for being coupled to said first connector, wherein the second connector having a second combining segment at one end thereof for being fastened to the bulb socket wherein the second combining segment has a second sidewall perpendicularly extending that comprises a second fixing portion for receiving said first fixing portion. Through foregoing structure, a bulb holder that can be fabricated easily and combined securely is therefore accomplished.

### BACKGROUND OF THE INVENTION

1. Technical Field

The present invention relates to a bulb holder with an improved structure, and more particularly, to a bulb holder with a coupling structure including a pair of connectors situated on a bulb socket and a base casing of the bulb holder which can be fabricated easily and securely joined.

2. Description of Related Art

A conventional bulb holder, as shown in FIG. 8, comprising a bulb socket 9, a base casing 8 and two screws 7, wherein the bulb socket 9 includes two holes 91 for allowing said two screws 7 to pass through and be further fixed at two holes 81 of base casing 8 to fixedly join the bulb socket 9 and base casing 8.

Another conventional bulb holder as can be seen in FIG. 9, has a bulb socket 9A, a base casing 8A and a nut 7A, wherein the bulb socket 9A has a threaded portion 91A passing through a hole 81A provided on the base casing 8A and coupling with the nut 7A to make foresaid components fixedly joined.

Generally, base casings and bulb sockets are shipped separately to customers where assembly of bulb holders is carried out. Therefore, assembly requiring assistance of auxiliary tools such as wrenches or screw drivers may be greatly inconvenient to the customer. Such conventional bulb holders are handicapped by time-consuming assembly, and specially, potential fractures in conducting wires caused by wire tangles during the screwing operation of assembly.

Thus, a need exists for a bulb holder with an improved structure that facilitates eliminating foresaid disadvantages of the fabrication of conventional bulb holders.

### SUMMARY OF THE INVENTION

The present invention has been accomplished under the circumstances in view. It is one object of the present invention to provide a bulb holder, having an improved coupling structure including connectors situated respectively on a bulb socket and a base casing thereof and coupling to accomplish easy assembly and securely joining thereon.

It is another object of the present invention to provide a bulb holder, which implements said coupling structure whereby the conductive wires can remain parallel during assembly so that fractures caused by wire tangles incurred by screwing during assembly can be eliminated.

To achieve these and other objects of the present invention, the disclosed subject matter comprises a bulb socket having a first connector with a first combining segment at one end thereof for being fastened to the bulb socket wherein the first combining segment has a first sidewall perpendicularly extending that comprises a first fixing portion, and a base casing having a second connector for being coupled to said first connector, wherein the second connector having a second combining segment at one end thereof for being fastened to the bulb socket wherein the second combining segment has a second sidewall perpendicularly extending that comprises a second fixing portion for receiving said first fixing portion.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a bulb holder according to the present invention;

FIG. 2 is an exploded view of the disclosed bulb holder;

FIG. 3 is an exploded view illustrating the coupling structure of the disclosed bulb holder;

FIG. 4 is a partially sectional view illustrating the coupling structure of the disclosed bulb holder;

FIG. 5 is an exploded view illustrating another embodiment of the coupling structure according to the present invention;

FIG. 6 is an exploded view illustrating still another embodiment of the coupling structure according to the present invention;

FIG. 7 is an exploded view illustrating yet another embodiment of the coupling structure according to the present invention;

FIG. 8 is a sectional view of the coupling structure of a conventional bulb holder; and

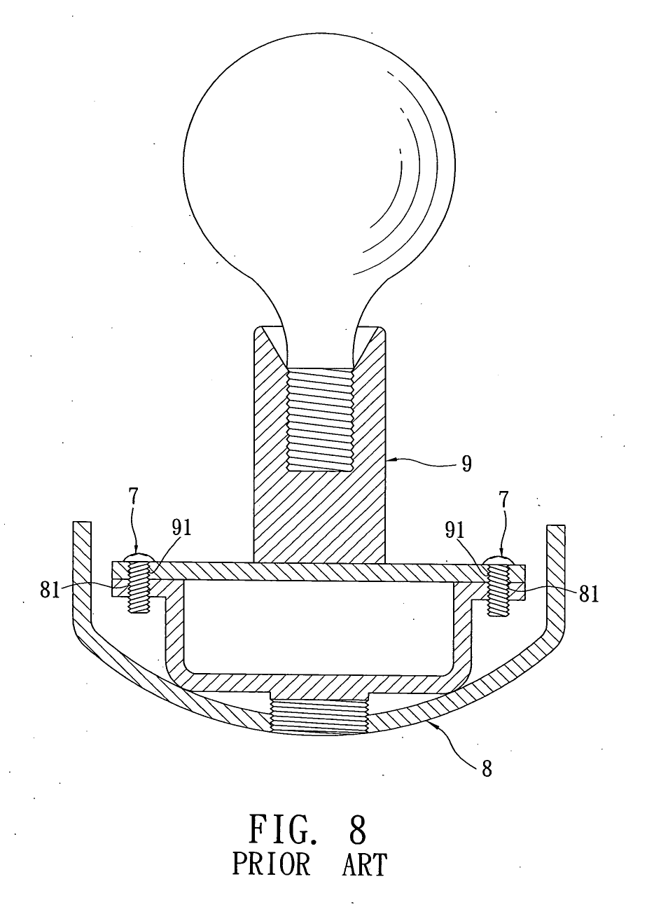

FIG. 9 is an exploded view of the coupling structure of the conventional bulb holder.

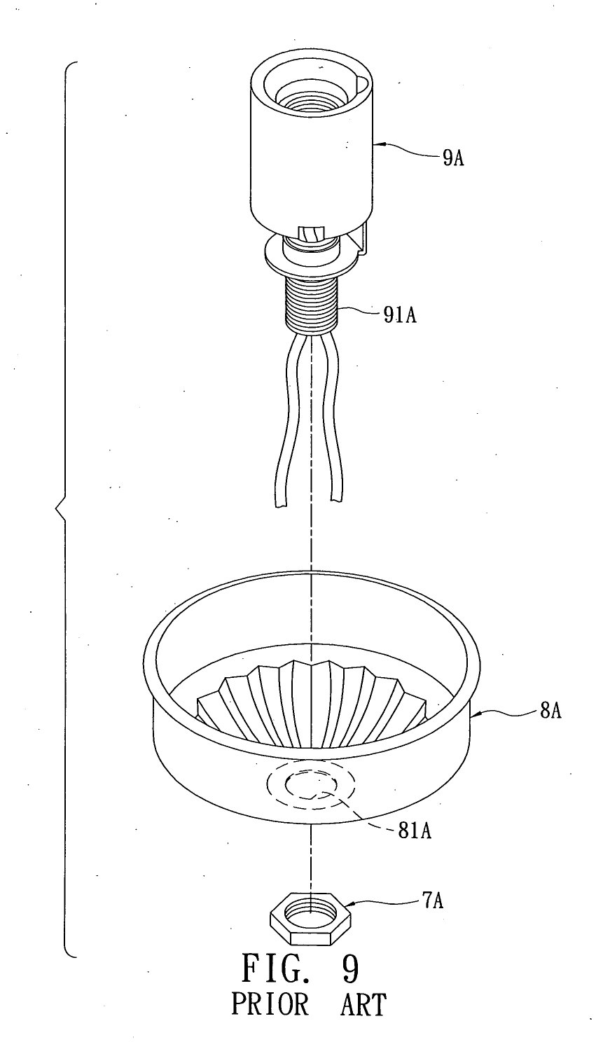

### DETAILED DESCRIPTION OF THE PREFERRED EMBODIMENT

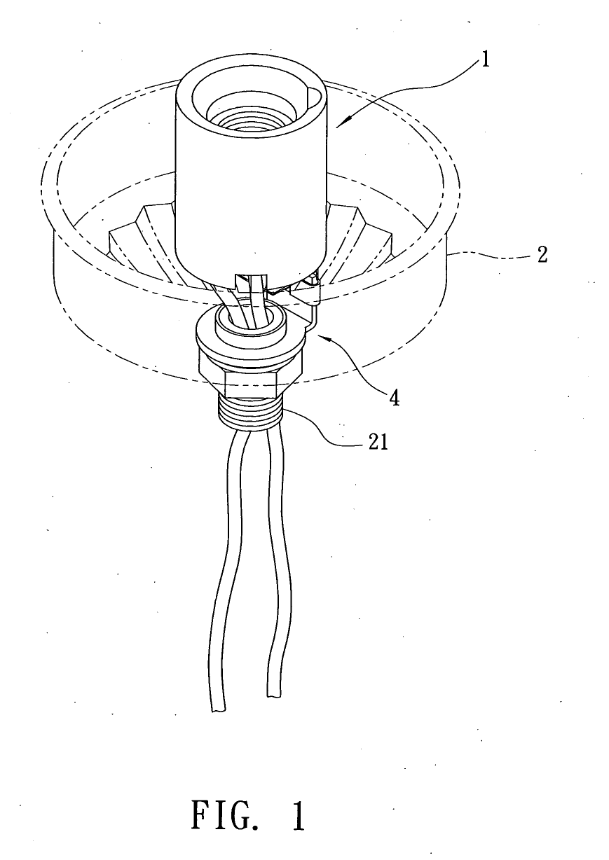

Please refer to FIGS. 1 to 7, which describe some preferred embodiments of the present invention. It is to be understood that the recited figures and embodiment are for illustrating and not intended to limit the structure of the present invention.

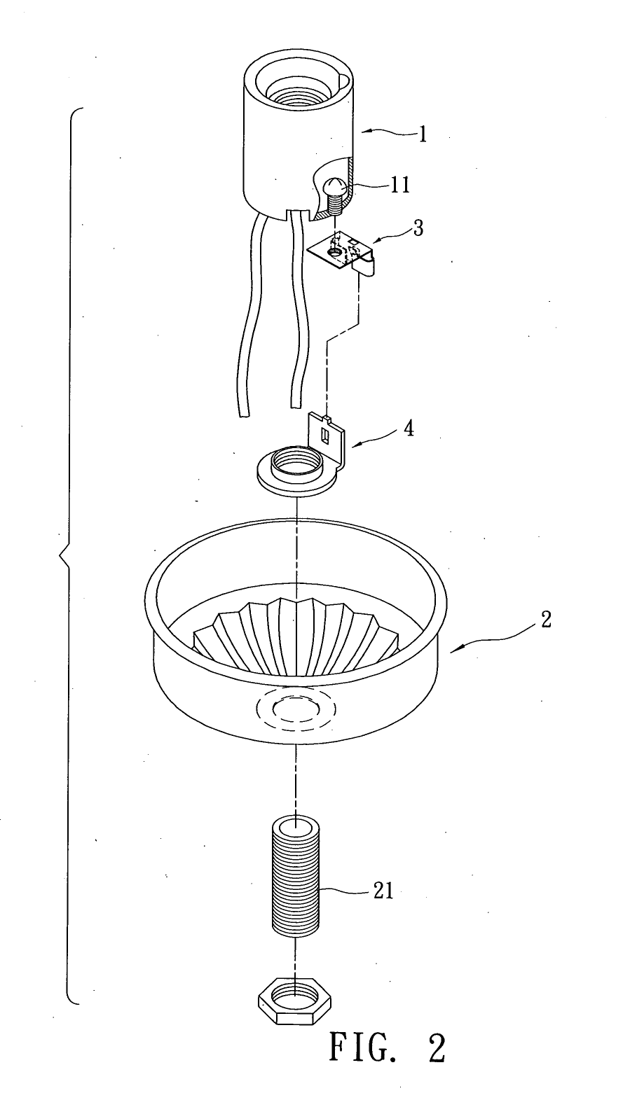

According to one embodiment of the present invention, the bulb holder with improved structure primarily comprises a bulb socket 1, a base casing 2, a first connector 3 and a second connector 4, wherein the first connector 3 is positioned at the bottom of the bulb socket 1 and has a fixing component 11 piercing through, while the second connector 4 is positioned in the base casing 2 by a fixing stud 21, as shown in FIG. 2.

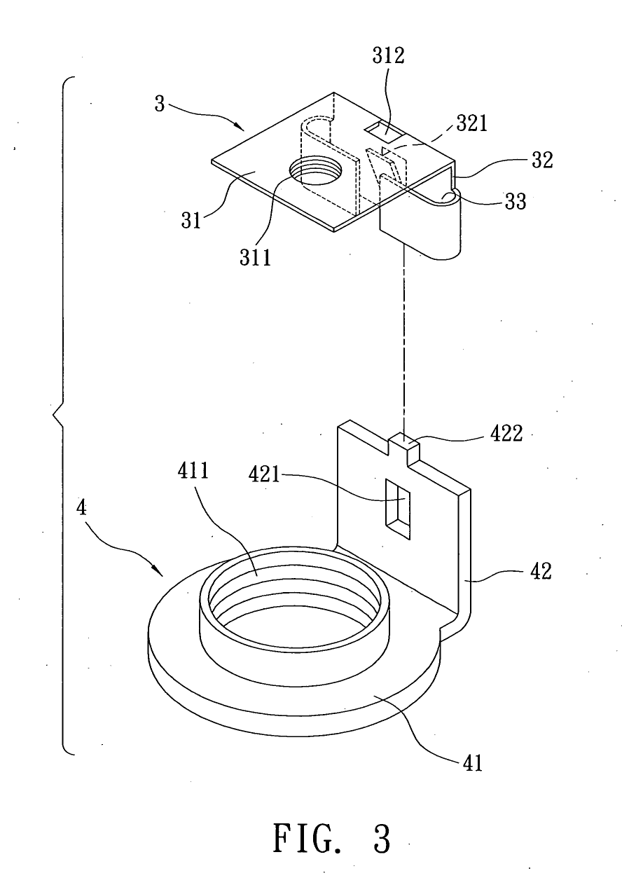

As can be seen in FIG. 3, the first connector 3 has a first combining segment 31. According to the present embodiment, the first combining segment 31 can be combined with the bulb socket 1 by the fixing component 11 piercing though a threaded hole 311 provided on the first combining segment 31. The first connector 3 further comprises a first sidewall 32 extending perpendicularly which has the opposite ends thereof extending and overturning to define an accommodating space 33. Additionally, the first sidewall 32 including a first fixing portion 321 (according to the present embodiment, it can be a resilient retaining piece) and the first combining segment 31 having an arresting hole 312 thereon.

Further, the second connector 4 has a second combining segment 41. According to the present embodiment, the second combining segment 41 is fixed in the base casing 2 with the threaded hole 411. Said second connector 4 further comprises a second sidewall 42 that is extending perpendicularly to be accommodated by the accommodating space 33 of the first connector 3 which has a second fixing portion 421 to receive said first fixing portion 321 (according to the present embodiment, it can be a through-hole) and a protruding arresting portion 422 to be coupled with the arresting hole 312 to ensure secure combination.

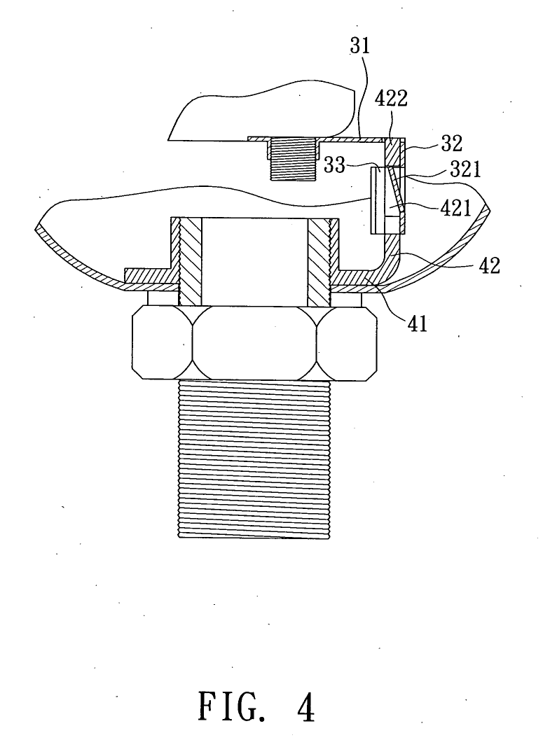

Please refer to FIG. 4 for the details of the coupling structure of the present invention. When the second sidewall 42 is inserted into the accommodating space 33, the resilient retaining clasp 321 can slip into and be retained by the through-hole 421 due to the resilience of the retaining clasp 321 and the arresting portion 422 can be positioned in the arresting hole 312 to make the connectors 3, 4 combined firmly. Otherwise, in the disclosed coupling structure, the first fixing portion 321 can be a through-hole while the second fixing portion 421 can be a resilient retaining clasp 321 so that the same result can be achieved.

In view of production, it is obvious that the disclosed coupling structure is advantageous because it can be easily and securely fabricated without the assistance of tools. That is to say, time and costs consumed by fabrication can be significantly reduced.

On the other hand, fabrication of the disclosed coupling structure requires no rotation of any component, so that the electric wires can be kept parallel mutually during fabrication and the security of usage of the bulb holder can be ensured.

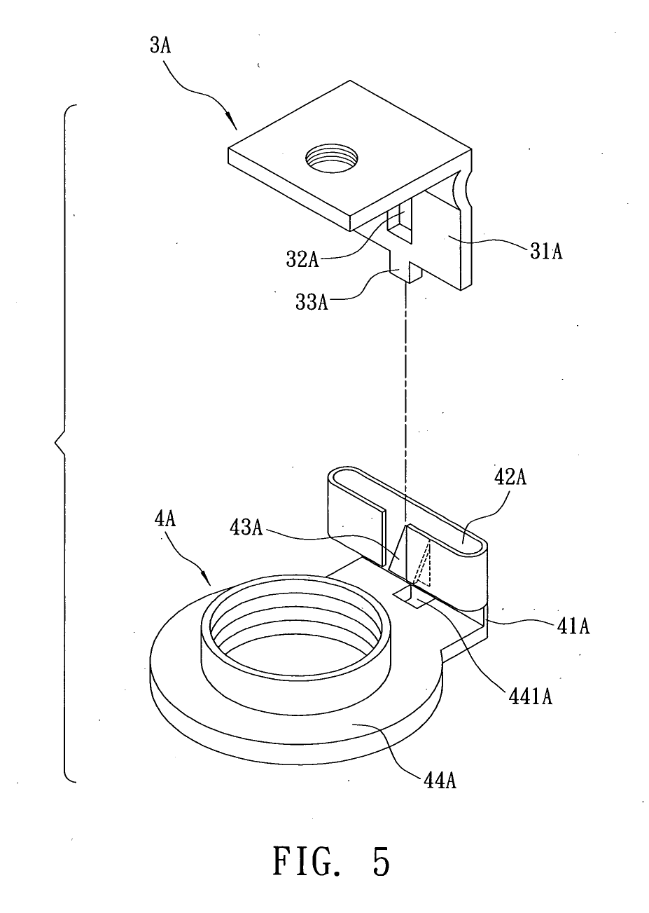

It is to be understood that there can be various embodiments of the present invention exist with slight modifications and variations. FIG. 5 is now provided for illustrating an alternative embodiment of the present invention. As can be seen in the drawing, in the second embodiment, the coupling structure provided on the first sidewall and second sidewall is dissimilar to that of the first embodiment.

According to FIG. 5, the first sidewall 31A has a first fixing portion 32A (according to the present embodiment, it can be a through-hole) which include a protruding arresting portion 33A at one end. The second sidewall 41A having the opposite ends thereof extending and overturning to define an accommodating space 42A and includes a second fixing portion 43A (according to the present embodiment, it can be a resilient retaining piece) that has an arresting hole 441A provided there-through. By the structure of the second embodiment, as the connectors 3A, 4A are coupled mutually, the retaining clasp 43A is retained in the through-hole 32A, and the arresting portion 33A is positioned in the arresting hole 441A so that the same result as the first embodiment can be achieved.

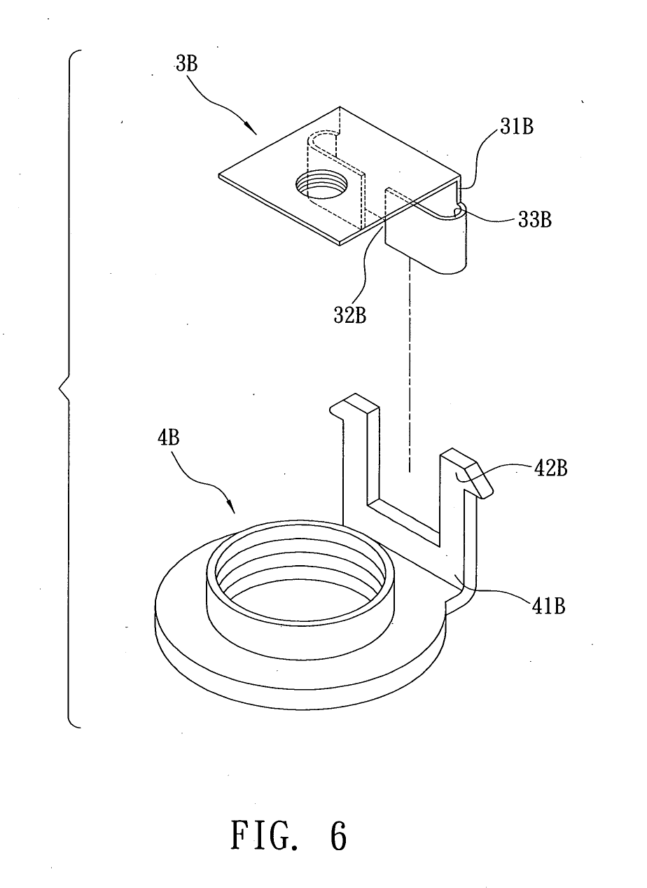

FIG. 6 describes a third embodiment of the present invention. Dissimilar to the first embodiment, the first sidewall 31B has the opposite ends thereof extending and overturning to form a pair of first fixing portions 33B that encircle an accommodating space 32B. The second sidewall 41B has a pair of symmetrical second fixing portions 42B (according to the present embodiment, the second fixing portions can be a pair of retaining clasps) for being retained by the two first fixing portions 33B respectively. So that after the second sidewall 41B is inserted into the accommodating space 32B, the connectors 3B, 4B can be combined due to the two retaining clasps 42B being retained by the two first fixing portions 33B.

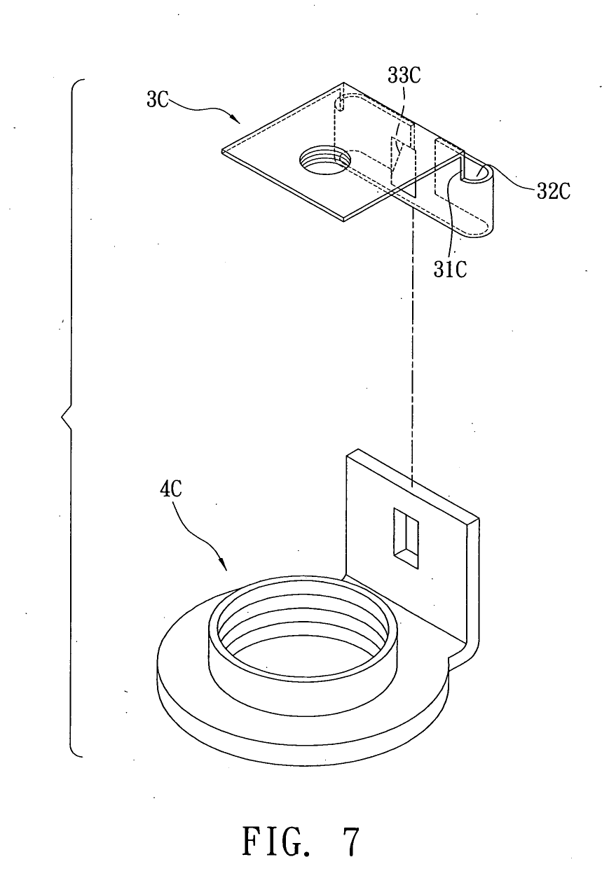

FIG. 7 is provided for explaining a fourth embodiment of the present invention. The present embodiment is dissimilar to the first embodiment by a varied coupling structure. According to the drawing, the first sidewall 31C has an accommodating space 32C and a resilient retaining clasp extending in a direction different form the direction of those in the first embodiment. Certainly, such structure can also achieve proper result.

What is claimed is:

1. A bulb holder with an improved structure which comprises:
a bulb socket, having a first connector which includes a first combining segment at one end for being fastened to the bulb socket that has a first sidewall extending perpendicularly that possesses a first fixing portion, and
a base casing, having a second connector for being coupled with the first connector which includes a second combining segment for being fastened to the base casing having a second sidewall extending perpendicularly that possesses a second fixing portion.

2. The bulb holder with the improved structure of claim 1, wherein the first sidewall has the opposite ends thereof extending and overturning to define an accommodating space for accommodating the second sidewall, and the first combining segment having an arresting hole while the second sidewall has a protruding arresting portion at one end for being positioned in the arresting hole so that after the second sidewall is inserted into the accommodating space, the first combining segment and second combining segment can be coupled mutually.

3. The bulb holder with the improved structure of claim 1, wherein the first sidewall has a protruding arresting portion at one end; the second sidewall has the opposite ends thereof extending and overturning to define an accommodating space; and, the second combining segment has an arresting hole so that after the connectors are combined, the first combining segment and second combining segment can be coupled mutually.

4. The bulb holder with the improved structure of claim 1, wherein the second fixing portion is a retaining clasp positioned on the second sidewall and the first fixing portion is formed by extending and overturning opposite ends of the first sidewall whereby the retaining clasp can be coupled by the first fixing portion to make the connectors combined.

5. The bulb holder with the improved structure of claim 1, wherein the first sidewall has the opposite ends thereof extending and overturning to define an accommodating space for accommodating the second sidewall whereby the first fixing portion can be coupled with the second fixing portion so that the connectors can be combined.

6. The bulb holder with the improved structure of claim 1, wherein the first fixing portion is a retaining clasp and the second fixing portion is a through-hole for receiving the retaining piece.

7. The bulb holder with the improved structure of claim 2, wherein the first fixing portion is a retaining clasp and the second fixing portion is a through-hole for receiving the retaining piece.

8. The bulb holder with the improved structure of claim 3, wherein the first fixing portion is a retaining clasp and the second fixing portion is a through-hole for receiving the retaining piece.

9. The bulb holder with the improved structure of claim 5, wherein the first fixing portion is a retaining clasp and the second fixing portion is a through-hole for receiving the retaining piece.

10. The bulb holder with the improved structure of claim 1, wherein the second fixing portion is a retaining clasp and the first fixing portion is a through-hole for receiving the retaining piece.

11. The bulb holder with the improved structure of claim 2, wherein the second fixing portion is a retaining clasp and the first fixing portion is a through-hole for receiving the retaining piece.

12. The bulb holder with the improved structure of claim 3, wherein the second fixing portion is a retaining clasp and the first fixing portion is a through-hole for receiving the retaining piece.

13. The bulb holder with the improved structure of claim 5, wherein the second fixing portion is a retaining clasp and the first fixing portion is a through-hole for receiving the retaining piece.
